(19) United States
(12) Patent Application Publication
(10) Pub. No.: US 2022/0225417 A1
(43) Pub. Date: Jul. 14, 2022

(54) METHOD AND APPARATUS FOR RANDOM ACCESS IN COMMUNICATION SYSTEM

(71) Applicant: ELECTRONICS AND TELECOMMUNICATIONS RESEARCH INSTITUTE, Daejeon (KR)

(72) Inventors: Soon Yong LIM, Daejeon (KR); Mi Jeong YANG, Daejeon (KR); Jae Sheung SHIN, Sejong-si (KR); Sung Min OH, Daejeon (KR)

(21) Appl. No.: 17/531,918

(22) Filed: Nov. 22, 2021

(30) Foreign Application Priority Data
Jan. 13, 2021 (KR) 10-2021-0004893

(51) Int. Cl. H04W 74/08

(52) U.S. Cl. CPC H04W 74/0833

(57) ABSTRACT

A method of operating a terminal in a communication system may include: receiving a message including first configuration information for a low-latency random access procedure from a base station; transmitting MsgA to the base station on the basis of the first configuration information; retransmitting the MsgA when MsgB, which is a response to the MsgA, is not received; and completing the random access procedure on the basis of information included in the MsgB when the MsgB is received in a section corresponding to the maximum number of low-latency transmissions indicated by first information included in the first configuration information.

### CROSS-REFERENCE TO RELATED APPLICATION

This application claims priority to Korean Patent Application No. 10-2021-0004893, filed on Jan. 13, 2021 with the Korean Intellectual Property Office (KIPO), the entire contents of which are hereby incorporated by reference.

### BACKGROUND

### 1. Technical Field

Exemplary embodiments of the present disclosure relate to a random access technique in a communication system, and more particularly, to a random access technique in a communication system such that transmission latency satisfies a latency requirement in a two-step random access procedure.

### 2. Description of Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

In order to process wireless data increasing rapidly after commercialization of the fourth generation (4G) communication system (e.g., long term evolution (LTE) communication system or LTE-Advanced (LTE-A) communication system), a fifth generation (5G) communication system (e.g., new radio (NR) communication system) using not only a frequency band (e.g., frequency band of 6 GHz or below) of the 4G communication system but also a frequency band (e.g., frequency band of 6 GHz or above) higher than the frequency band of the 4G communication system is being considered. The 5G communication system may support enhanced Mobile BroadBand (eMBB), Ultra-Reliable and Low Latency Communication (URLLC), and massive Machine Type Communication (mMTC).

In a communication system, a terminal may perform a random access procedure for connection to a base station. In the random access procedure, messages can be exchanged between a terminal and a base station, and the new radio (NR) specified in the 3rd Generation Partnership Project (3GPP) standard is a two-step (2-step) random access procedure that can perform random access faster than the existing four-step (4-step) random access procedure. In this two-step random access procedure, when the terminal does not receive a response signal for MsgA from the base station, MsgA may be retransmitted. In this case, the transmission latency of MsgA may not satisfy the latency requirement.

### SUMMARY

Accordingly, exemplary embodiments of the present disclosure are provided to substantially obviate one or more problems due to limitations and disadvantages of the related art.

Exemplary embodiments of the present disclosure provide a method and apparatus for a two-step random access procedure that satisfies a latency requirement in a communication system.

According to a first exemplary embodiment of the present disclosure, a method of operating a terminal in a communication system may comprise: receiving a message including first configuration information for a low-latency random access procedure from a base station; transmitting MsgA to the base station on the basis of the first configuration information; retransmitting the MsgA when MsgB, which is a response to the MsgA, is not received; and completing the random access procedure on the basis of information included in the MsgB when the MsgB is received in a section corresponding to the maximum number of low-latency transmissions indicated by first information included in the first configuration information.

The message may further include second configuration information for a normal random access procedure, and the second configuration information may be set independently of the first configuration information.

The MsgA may be transmitted based on the first configuration information when the transmission of low-latency data is required, the MsgA may be transmitted based on the second configuration information when the transmission of normal data is required, and transmission latency required for the low-latency data may be shorter than transmission latency required to transmit the normal data.

The transmitting of MsgA to the base station on the basis of the first configuration information for the low-latency random access procedure may comprise: selecting a random access preamble; generating a random access payload; generating the MsgA including the random access preamble and the random access payload; transmitting the MsgA to the base station; and increasing a preamble transmission counter indicating the number of transmissions of MsgA.

When the transmission of the low-latency data is required, the random access payload may include a medium access control (MAC) control element (CE) including the low-latency data.

A low-latency response window indicated by second information included in the first configuration information may be started when the MsgA is transmitted, and the MsgA may be retransmitted when the MsgB is not received within the low-latency response window.

The method may further comprise performing a normal two-step random access procedure when the MsgB is not received in the section corresponding to the maximum number of low-latency transmissions, wherein the maximum number of transmissions for the normal two-step random access procedure is greater than the maximum number of low-latency transmissions.

According to a second exemplary embodiment of the present disclosure, a method of operating a base station in a communication system may comprise: setting first configuration information for a low-latency random access procedure; setting second configuration information for a normal random access procedure; transmitting a message including the first configuration information and the second configuration information for the normal random access procedure to a terminal; receiving MsgA from the terminal on the basis of information elements included in the message; and transmitting MsgB to the terminal in response to the MsgA, wherein the first configuration information is set to satisfy a low-latency requirement.

The first configuration information may comprise first information indicating the maximum number of low-latency transmissions of the MsgA, second information indicating a low-latency response window for the MsgB, and a low-latency transmission indicator.

The maximum number of transmissions indicated by the second configuration information may be greater than the maximum number of low-latency transmissions of the MsgA.

When MsgA includes a cell-radio network temporary identifier (C-RNTI) for the low-latency random access procedure, the operation of transmitting the MsgB may be performed based on the first configuration information.

According to a third exemplary embodiment of the present disclosure, a terminal may comprise: a processor; a memory configured to electronically communicate with the processor; and instructions stored in the memory, wherein when the instructions are executed by the processor, the instructions allow the terminal to: receive a message including first configuration information for a low-latency random access procedure from a base station; transmit MsgA to the base station on the basis of the first configuration information; retransmit the MsgA when MsgB, which is a response to the MsgA, is not received; and complete the random access procedure on the basis of information included in the MsgB when the MsgB is received in a section corresponding to the maximum number of low-latency transmissions indicated by first information included in the first configuration information.

The message may further include second configuration information for a normal random access procedure, and the second configuration information may be set independently of the first configuration information.

The MsgA may be transmitted based on the first configuration information when the transmission of low-latency data is required, the MsgA may be transmitted based on the second configuration information when the transmission of normal data is required, and transmission latency required for the low-latency data may be shorter than transmission latency required to transmit the normal data.

When transmitting MsgA to the base station on the basis of the first configuration information for the low-latency random access procedure, the instructions may allow the terminal to: select a random access preamble; generate a random access payload; generate the MsgA including the random access preamble and the random access payload; transmit the MsgA to the base station; and increase a preamble transmission counter indicating the number of transmissions of MsgA.

The instructions may allow the terminal to perform a normal two-step random access procedure when the MsgB is not received in the section corresponding to the maximum number of low-latency transmissions, and the maximum number of transmissions for the normal two-step random access procedure may be greater than the maximum number of low-latency transmissions.

According to the present disclosure, when MsgA has a low-latency requirement, a terminal can set a latency requirement for transmission latency of the MsgA as the maximum number of low-latency transmissions of the MsgA.

Accordingly, when the number of retransmissions of MsgA is within the maximum number of low-latency transmissions of MsgA, the terminal can perform a low-latency two-step random access procedure for transmission of low-latency data so that the transmission latency of MsgA meets the latency requirement.

Also, according to the present disclosure, when the terminal does not receive MsgB while the number of retransmissions of MsgA exceeds the maximum number of low-latency transmissions of MsgA, this is treated as being unsuccessfully completed, and an MsgA buffer where the MsgA has been stored is discarded. Thus, it is possible to save resources.

### BRIEF DESCRIPTION OF DRAWINGS

FIG. 1 is a conceptual diagram illustrating an exemplary embodiment of a communication system.

FIG. 2 is a block diagram illustrating a first exemplary embodiment of a communication node constituting a communication system.

FIG. 3 is a flowchart illustrating a first embodiment of a normal two-step random access procedure.

FIG. 4 is a conceptual view showing a first embodiment of a normal two-step random access procedure.

FIG. 5 is a conceptual view showing a first embodiment of a low-latency two-step random access procedure.

FIG. 6 is a flowchart illustrating a first embodiment of a low-latency two-step random access procedure.

FIG. 7 is a flowchart illustrating a detailed transmission process of MsgA of FIG. 6.

FIGS. 8A and 8B are flowcharts illustrating an MsgB reception operation of FIG. 6.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

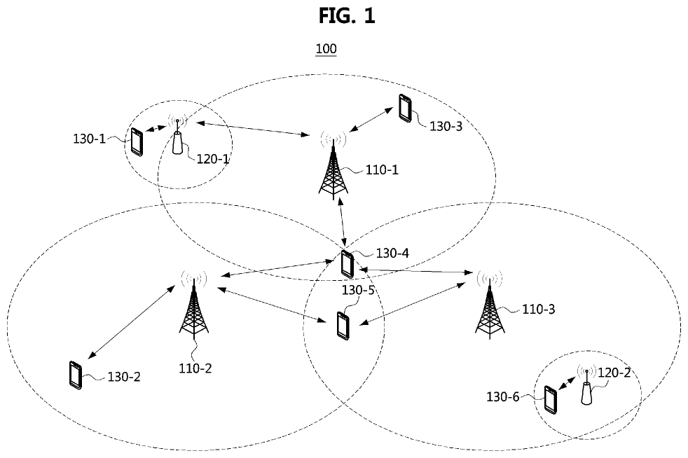

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4^{th} generation (4G) communication (e.g., long term evolution (LTE), LTE-advanced (LTE-A)), 5^{th} generation (5G) communication (e.g., new radio (NR)), or the like. The 4G communication may be performed in a frequency band of 6 GHz or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

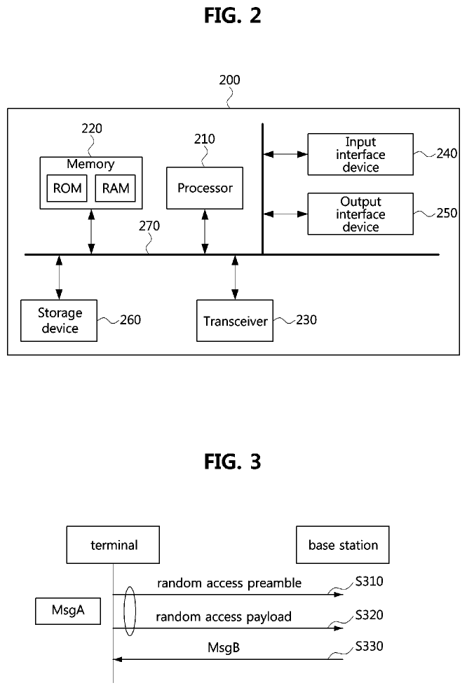

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each of the components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring back to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

The plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

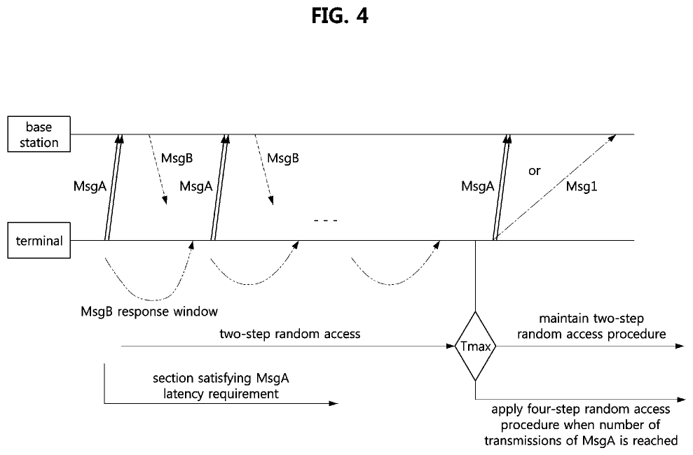

FIG. 3 is a flowchart illustrating a first embodiment of a normal two-step random access procedure.

Referring to FIG. 3, in the normal two-step random access procedure, a terminal may transmit MsgA including a random access payload and a random access preamble to a base station (S310, S320). In this case, the random access preamble may be transmitted on a physical random access channel (PRACH), and the random access payload may be transmitted on a physical uplink shared channel (PUSCH). In this case, the random access payload may include data. That is, the two-step random access procedure may be used to transmit data (e.g., a small amount of data). Here, the data may be low-latency data. In embodiments, the low-latency data may be data that is transmitted to satisfy low-latency requirement(s). The base station may receive MsgA from the terminal and may transmit MsgB including information necessary for contention resolution to the terminal (S330). In this way, the terminal may transmit data to the base station with short transmission latency using MsgA.

Due to the characteristics of the normal two-step random access procedure, the normal two-step random access procedure may be usefully used in a communication system requiring low-latency traffic processing such as in the field of factory automation. However, when the communication system adopts a normal two-step random access procedure, contention resolution may not be properly performed, and thus MsgA may be retransmitted. When the terminal retransmits MsgA, the latency requirement may not be satisfied due to the transmission latency of MsgA.

Accordingly, the number of transmissions (e.g., the maximum number of transmissions) of MsgA may be limited in order to ensure that the transmission latency of MsgA satisfies the latency requirement in the communication system. Accordingly, when the two-step random access procedure according to the low-latency requirement is performed, the number of transmissions of MsgA may be set to be limited. Then, the terminal may retransmit MsgA less than a set number of times so that the old MsgA is not transmitted.

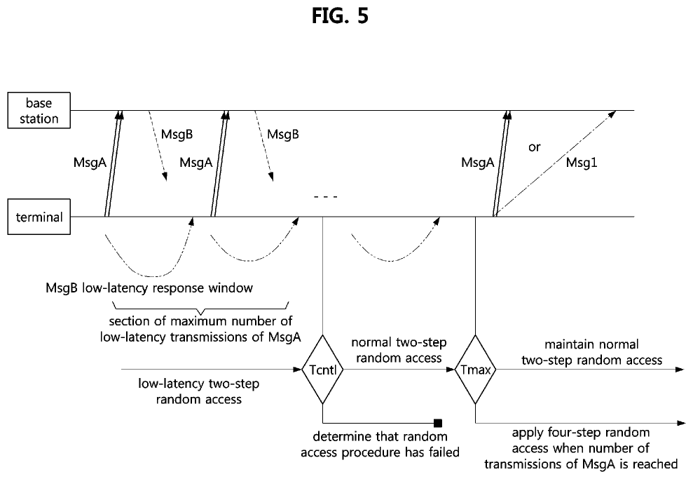

FIG. 4 is a conceptual view showing a first embodiment of a normal two-step random access procedure.

Referring to FIG. 4, in the two-step random access procedure, a terminal may start MsgB response window (msgB-ResponseWindow) after transmitting MsgA. The terminal may retransmit MsgA when not receiving MsgB during the MsgB response window. In this case, the terminal may attempt to retransmit MsgA as many times as the maximum number of transmissions (msgA-TransMax; Tmax) of MsgA. Also, the terminal may terminate the two-step random access procedure when the retransmission of MsgA reaches the maximum number of transmissions. Here, the two-step random access procedure may be switched into a four-step (4-step) random access procedure.

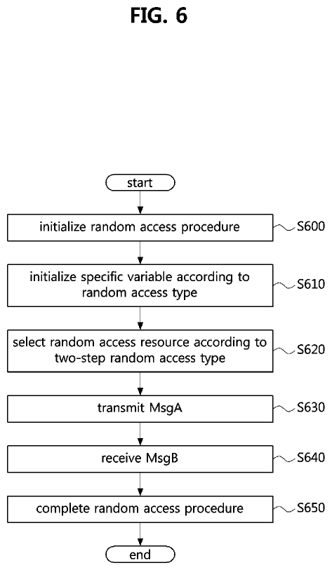

In this process, the terminal may retransmit MsgA even after a section satisfying the latency requirement of MsgA (e.g., a “latency requirement satisfaction section”) passes. In this case, resources may be wasted due to the unnecessary transmission of Msga. In order to solve this problem, as shown in FIG. 5 below, a section satisfying the latency requirement of the low-latency data included in MsgA (e.g., Msga) may be set, and Msga may not be retransmitted when the above section passes.

FIG. 5 is a conceptual view showing a first embodiment of a low-latency two-step random access procedure.

Referring to FIG. 5, in the low-latency two-step random access procedure, a terminal may transmit MsgA to a base station and may start MsgB low-latency response window after transmitting MsgA. Here, MsgA (e.g., a random access payload of MsgA) may include low-latency data. The MsgB low-latency response window may be set independently of the conventional response window (e.g., a response window in the normal two-step random access procedure). For example, the MsgB low-latency response window may be set to be shorter than the conventional response window.

The terminal may perform a monitoring operation for receiving MsgB in the MsgB low-latency response window. The terminal may retransmit MsgA when not receiving MsgB in the MsgB low-latency response window. When the maximum number of low-latency transmissions of MsgA is set according to the low-latency requirement, the terminal may retransmit MsgA when the number of retransmissions of MsgA is less than or equal to the maximum number of low-latency transmissions of MsgA.

Meanwhile, the terminal may determine that the random access procedure has failed when MsgB is not received in a section corresponding to the maximum number of low-latency transmissions of MsgA. When it is determined that the low-latency two-step random access procedure fails, the terminal may discard MsgA stored in a buffer (e.g., MsgA buffer). Accordingly, the base station may not receive MsgA from the terminal when the section corresponding to the maximum number of low-latency transmissions of MsgA passes. In this case, the base station may not transmit MsgB in response to MsgA.

Here, the terminal may perform the normal two-step random access procedure or the 4-step random access procedure. When the normal two-step random access procedure is performed, the terminal may start MsgB response window (msgB-ResponseWindow) after transmitting MsgA. The terminal may retransmit MsgA when not receiving MsgB during the MsgB response window. In this case, the terminal may attempt to retransmit MsgA as many times as the maximum number of transmissions of MsgA. The maximum number of transmissions in the normal two-step random access procedure may be greater than the maximum number of transmissions in the low-latency two-step random access procedure. Also, the terminal may switch the two-step random access procedure into the 4-step random access procedure when the retransmission of MsgA reaches the maximum number of transmissions.

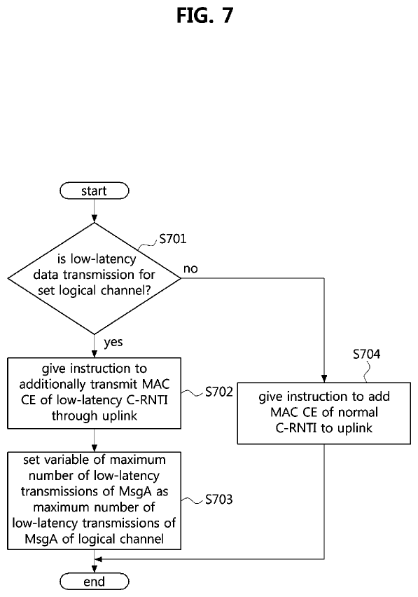

FIG. 6 is a flowchart illustrating a first embodiment of a low-latency two-step random access procedure.

Referring to FIG. 6, a random access procedure initialization operation may be performed between a terminal and a base station (S600). The base station may set configuration information for a low-latency two-step random access procedure. For example, the base station may set the maximum number of low-latency transmissions of MsgA, an MsgB low-latency response window, an MsgA low-latency transmission indicator, etc. Also, the base station may transmit, to the terminal, a message (e.g., system information and/or radio resource control (RRC) message) including the configuration information (e.g., the maximum number of low-latency transmissions of MsgA, the MsgB low-latency response window, the MsgA low-latency transmission indicator, etc.) for the low-latency two-step random access procedure. The three pieces of information, that is, the maximum number of low-latency transmissions of MsgA, the MsgB low-latency response window, and the MsgA low-latency transmission indicator may be transmitted through the same RRC message or through different RRC messages.

Also, the base station may set configuration information for a normal two-step random access procedure. For example, the base station may set the maximum number of transmissions of MsgA, the MsgB response window, etc. Also, the base station may transmit, to the terminal, a message (e.g., the system information and/or the RRC message) including the configuration information (e.g., the maximum number of transmissions of MsgA, the MsgB response window, etc.) for the normal two-step random access procedure. The configuration information for the low-latency two-step random access procedure and the configuration information for the normal two-step random access procedure may be included in the same message or in different messages.

The terminal may confirm the configuration information for the low-latency two-step random access procedure and/or the configuration information for the normal two-step random access procedure by receiving the message (e.g., system information and/or RRC message) from the base station. The above-described parameters may be defined in Table 1 below.

TABLE 1

| Parameters | Details | Parameter Configuration |
|---|---|---|
| msgA- | Maximum number | An RRC layer may allow |
| TransControl | of low-latency | the maximum number of |
| | transmissions of | low-latency transmissions |
| | MsgA | of MsgA to be set for a |
| | | logical channel. |
| msgB- | MsgB low-latency | An RRC layer may allow |
| ResponseWindow- | response window | the MsgB low-latency |
| TransControl | | response window to be set |
| | | for the configuration |
| | | information of RACH. |
| msgA-TRANS- | MsgA low-latency | An RRC layer may allow |
| CONTROL- | transmission | the MsgA low-latency |
| PUSCH | indicator | transmission indicator to |
| | | be set for the configuration |
| | | information of PUSCH. |
| msgA-TransMax | Maximum number | An RRC layer may allow |
| | transmissions of | of the maximum number of |
| | MsgA | transmissions of MsgA to |
| | | be set for a terminal. |
| msgB-Re- | MsgB response | An RRC layer may allow |
| sponseWindow | window | the MsgB response |
| | | window to be set for the |
| | | configuration information |
| | | of RACH. |

On the other hand, a logical channel of an uplink-shared channel (UL-SCH) for the low-latency two-step random access procedure (hereinafter, referred to as a “low-latency RA logical channel”) may be set. An identifier (e.g., a logical channel identifier (LCD)) of the low-latency RA logical channel may be defined as shown in Table 2 below. For example, a specific value (e.g., 35) may be set as the identifier of the low-latency RA logical channel.

TABLE 2
LCID of UL-SCH

| Codepoint/index | LCID values |
|---|---|
| 35 | msgA-Transcontrol C-RNTI |

Accordingly, in the MsgA transmission operation (S630) which will be described below, the terminal may generate a medium access control (MAC) sub-protocol data unit (subPDU) including an MAC subheader including the identifier of the low-latency RA logical channel and a MAC control element (CE) including low-latency data. The MAC subPDU may be included in the random access payload of MsgA. Subsequently, the terminal may initialize specific variables according to the type of the random access procedure (S610). As an example, the MAC entity of the terminal may initialize MSGA-TRANSCONTROL, which is a variable of the maximum number of low-latency transmissions of MsgA used to specify the maximum number of low-latency transmissions of MsgA when the type of the random access procedure is the low-latency 2-step random access procedure, to zero.

Subsequently, the terminal may select a random access resource according to the two-step random access type (S620). Resources for the low-latency two-step random access procedure (e.g., a random access preamble, PRACH resources (e.g., PRACH occasion (occasion)), PUSCH resources (e.g., PUSCH occasion), etc.) may be set independently of resources for the normal two-step random access procedure. The resources for the low-latency two-step random access procedure and/or the resources for the normal two-step random access procedure may be set in operation S600. For example, the terminal may select a random access preamble on the basis of system information received from the base station. In order to select the random access resources according to the two-step random access type, first, the MAC entity of the terminal may determine whether a random access preamble is selected from among contention-based random access (CBRA) preambles. When the MAC entity of the terminal does not select the random access preamble from among the contention-based random access preambles, the MAC entity may select one PUSCH occasion from among PUSCH occasions configured in the PUSCH (msgA-CFRA-PUSCH) of a contention-free random access (CFRA) of MsgA.

In contrast, the MAC entity of the terminal may determine whether the random access preamble is selected from among the contention-based random access preambles and may determine whether to execute the low-latency two-step random access procedure when the random access preamble is selected from among the contention-based random access preambles. Here, the terminal may determine whether to execute the low-latency two-step random access procedure by determining whether MSGA-TRANSCONTROL, which is a variable of the maximum number of low-latency transmission of MsgA, is triggered with a non-zero value and whether the MsgA low-latency transmission indicator is set. That is, when the variable MSGA-TRANSCONTROL is triggered with a non-zero value, the terminal may execute the low-latency two-step random access procedure when the MsgA low-latency transmission indicator is set.

As described above, the terminal may determine whether to execute the low-latency two-step random access procedure and may select a PUSCH occasion from among PUSCH occasions corresponding to the MsgA low-latency transmission indicator when it is necessary to proceed with the low-latency two-step random access procedure.

In contrast, when the terminal does not require the execution of the low-latency two-step random access procedure (i.e., when MSGA-TRANSCONTROL, which is the variable of the maximum number of low-latency transmissions of MsgA, is zero and the MsgA low-latency transmission indicator is not set), the terminal may select a PUSCH occasion from among PRACH occasions and a preamble selected according to the normal two-step random access procedure.

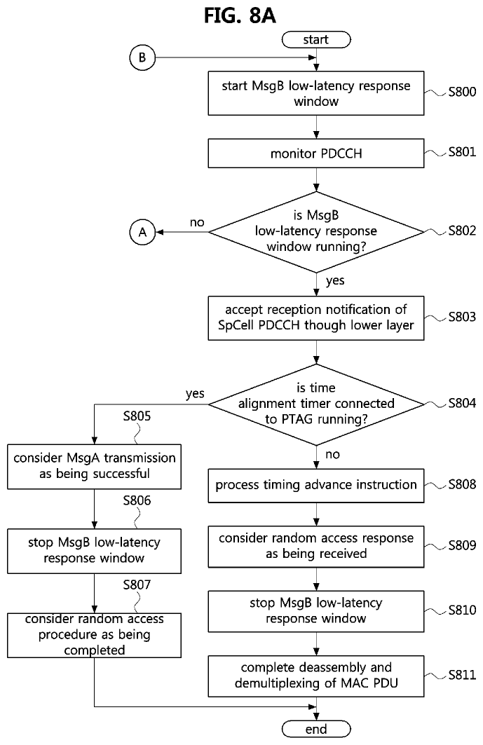

Meanwhile, the terminal may generate MsgA including a random access preamble and a random access payload and may transmit the generated MsgA to a base station (S630). The MAC entity of the terminal may perform the same procedure on each MsgA as in the flowchart shown in FIG. 7.

FIG. 7 is a flowchart illustrating a detailed transmission process of MsgA of FIG. 6.

Referring to FIG. 7, in the MsgA transmission process, a MAC entity of a terminal may determine whether a first MsgA transmission in a random access procedure is a transmission that is performed in a logical channel configured for a low-latency data transmission (e.g., a low-latency two-step random access procedure) (S701). Here, when a parameter (e.g., the maximum number of low-latency transmissions of MsgA, etc.) for the low-latency two-step random access procedure is set in a logical channel, the terminal may determine that the logical channel is set for a low-latency data transmission.

When the transmission is a transmission for the logical channel configured for the low-latency data transmission, the MAC entity of the terminal may instruct a multiplexing and assembly entity of the terminal to transmit a random access payload including a low-latency C-RNTI MAC CE (S702). Here, the low-latency C-RNTI MAC CE may refer to a MAC CE including low-latency data.

Also, the MAC entity of the terminal may set the variable of the maximum number of low-latency transmissions of MsgA as the maximum number of low-latency transmissions of MsgA of the logical channel (S703). In contrast, when the transmission is not a transmission for the logical channel configured for the low-latency data transmission, the MAC entity of the terminal may instruct the multiplexing and assembly entity of the terminal to transmit a random access payload including a normal C-RNTI MAC CE for the normal two-step random access procedure through an uplink (S704).

Referring back to FIG. 6, the base station may receive MsgA from the terminal and may resolve contention by transmitting MsgB to the terminal in response to MsgA. MsgB may be transmitted within a response window. The terminal may receive MsgB from the base station and may complete the random access procedure on the basis of information included in MsgB (S640). In the low-latency two-step random access procedure, when MsgB is received within a section corresponding to the maximum number of low-latency transmissions of MsgA, the terminal may determine that the random access procedure is successfully completed.

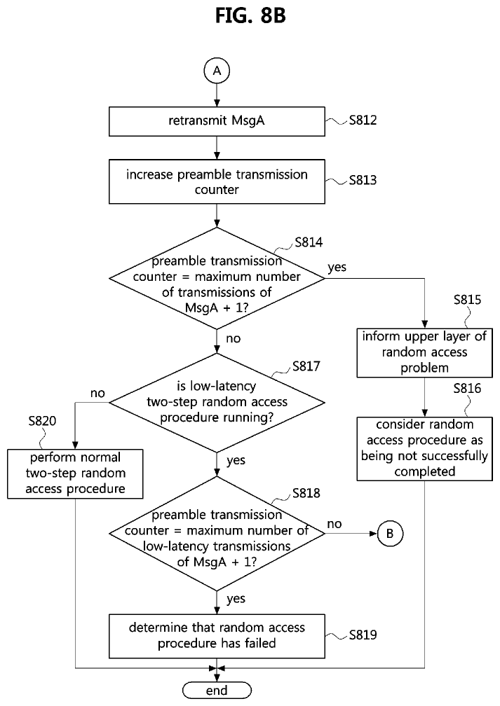

FIGS. 8A and 8B are flowcharts illustrating an MsgB reception operation of FIG. 6.

Referring to FIGS. 8A and 8B, the terminal may start an MsgB low-latency response window in the MsgB reception operation. In addition, the terminal may perform a monitoring operation on a physical downlink control channel (PDCCH) of SpCell to receive MsgB (e.g., a random access response) identified by a C-RNTI (S801).

The MAC entity of the terminal may accept a reception notification for the PDCCH of the SpCell in a lower layer (e.g., the PHY layer) during the MsgB low-latency response window (S802) (S803). When the reception notification of the PDCCH of the SpCell is accepted in the lower layer, the MAC entity of the terminal may determine whether a time alignment timer (timeAlignmentTimer) connected to a primary serving cell timing advance group (PTAG) is running (S804). At this time, the MAC entity of the terminal may determine whether the time alignment timer associated with the PTAG is running when the low-latency C-RNTI MAC CE is included in MsgA.

Meanwhile, when the time alignment timer connected to the PTAG is running and the PDCCH (e.g., DCI) indicated by the C-RNTI includes a UL grant for a new transmission, the MAC entity of the terminal may consider that the MsgA transmission is successful (S805). Accordingly, the MAC entity of the terminal may stop the MsgB low-latency response window (S806) and may consider that the random access procedure has been successfully completed (S807).

In contrast, when the time alignment timer associated with the PTAG is not running, the MAC entity of the terminal may perform an operation based on a timing advance command included in the MAC PDU (S808). At this time, the MAC entity of the terminal may acquire downlink allocation information for the C-RNTI from the PDCCH and may perform an operation based on the received timing advance command when a received transport block (TB) is successfully decoded.

Also, when the reception of a random access response is considered to be successful (S809), the MAC entity of the terminal may stop the MsgB low-latency response window (S810). The MAC entity of the terminal may consider that the random access procedure has been successfully completed and may complete the disassembly and de-multiplexing operation of the MAC PDU (S811).

Meanwhile, when the MsgB low-latency response window is terminated while the reception of a random access response is not successful (S802), the MAC entity of the terminal may retransmit MsgA (S812). In this case, the MAC entity of the terminal may increment a preamble transmission counter (PREAMBLE_TRANSMISSION_COUNTER) (S812). In this case, the MAC entity of the terminal may determine whether the counter value of the preamble transmission counter is equal to the maximum number of transmissions of MsgA plus one (S814).

When the counter value of the preamble transmission counter is equal to the maximum number of transmissions of MsgA plus one, the MAC entity of the terminal may inform the upper layer of the problem of random access (S815). Also, the MAC entity of the terminal may be considered as not successfully completing the low-latency two-step random access procedure (S816).

Meanwhile, as the determination result in S814, when the counter value of the preamble transmission counter is not equal to the maximum number of transmissions of MsgA plus one, the MAC entity of the terminal may determine whether the low-latency two-step random access procedure is running (S817). Accordingly, the MAC entity of the terminal may determine whether the counter value of the preamble transmission counter is equal to the maximum number of low-latency transmissions of MsgA plus one (S818).

When the counter value of the preamble transmission counter is equal to the maximum number of low-latency transmissions of MsgA plus one, the MAC entity of the terminal may determine that the random access procedure has failed (S819). In contrast, when the counter value of the preamble transmission counter is not equal to the maximum number of low-latency transmissions of MsgA plus one, the MAC entity of the terminal may repeat the above operations, starting from the operation of starting the MsgB low-latency response window (S800).

In contrast, when the variable of the maximum number of low-latency transmissions of MsgA is triggered with zero in a normal two-step random access procedure, the MAC entity of the terminal may perform a random access resource selection procedure according to the normal two-step random access procedure (S820).

Referring to FIG. 6 again, when MsgB is received in a section corresponding to the maximum number of low-latency transmissions of MsgA, the terminal may complete the random access procedure on the basis of information included in MsgB.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method of operating a terminal in a communication system, the method comprising:
receiving a message including first configuration information for a low-latency random access procedure from a base station;
transmitting MsgA to the base station on the basis of the first configuration information;
retransmitting the MsgA when MsgB, which is a response to the MsgA, is not received; and
completing the random access procedure on the basis of information included in the MsgB when the MsgB is received in a section corresponding to the maximum number of low-latency transmissions indicated by first information included in the first configuration information.

2. The method of claim 1, wherein the message further includes second configuration information for a normal random access procedure, and the second configuration information is set independently of the first configuration information.

3. The method of claim 2, wherein the MsgA is transmitted based on the first configuration information when the transmission of low-latency data is required, the MsgA is transmitted based on the second configuration information when the transmission of normal data is required, and transmission latency required for the low-latency data is shorter than transmission latency required to transmit the normal data.

4. The method of claim 1, wherein the transmitting of MsgA to the base station on the basis of the first configuration information for the low-latency random access procedure comprises:
selecting a random access preamble;
generating a random access payload;
generating the MsgA including the random access preamble and the random access payload;
transmitting the MsgA to the base station; and
increasing a preamble transmission counter indicating the number of transmissions of MsgA.

5. The method of claim 4, wherein when the transmission of the low-latency data is required, the random access payload includes a medium access control (MAC) control element (CE) including the low-latency data.

6. The method of claim 1, wherein a low-latency response window indicated by second information included in the first configuration information is started when the MsgA is transmitted, and the MsgA is retransmitted when the MsgB is not received within the low-latency response window.

7. The method of claim 1, further comprising performing a normal two-step random access procedure when the MsgB is not received in the section corresponding to the maximum number of low-latency transmissions,
wherein the maximum number of transmissions for the normal two-step random access procedure is greater than the maximum number of low-latency transmissions.

8. A method of operating a base station in a communication system, the method comprising:
setting first configuration information for a low-latency random access procedure;
setting second configuration information for a normal random access procedure;
transmitting a message including the first configuration information and the second configuration information for the normal random access procedure to a terminal;
receiving MsgA from the terminal on the basis of information elements included in the message; and
transmitting MsgB to the terminal in response to the MsgA,
wherein the first configuration information is set to satisfy a low-latency requirement.

9. The method of claim 8, wherein the first configuration information comprises first information indicating the maximum number of low-latency transmissions of the MsgA, second information indicating a low-latency response window for the MsgB, and a low-latency transmission indicator.

10. The method of claim 9, wherein the maximum number of transmissions indicated by the second configuration information is greater than the maximum number of low-latency transmissions of the MsgA.

11. The method of claim 8, wherein when MsgA includes a cell-radio network temporary identifier (C-RNTI) for the low-latency random access procedure, the operation of transmitting the MsgB is performed based on the first configuration information.

12. A terminal comprising:
a processor;
a memory configured to electronically communicate with the processor; and
instructions stored in the memory,
wherein when the instructions are executed by the processor, the instructions allow the terminal to:
receive a message including first configuration information for a low-latency random access procedure from a base station;
transmit MsgA to the base station on the basis of the first configuration information;
retransmit the MsgA when MsgB, which is a response to the MsgA, is not received; and
complete the random access procedure on the basis of information included in the MsgB when the MsgB is received in a section corresponding to the maximum number of low-latency transmissions indicated by first information included in the first configuration information.

13. The terminal of claim 12, wherein the message further includes second configuration information for a normal random access procedure, and the second configuration information is set independently of the first configuration information.

14. The terminal of claim 13, wherein the MsgA is transmitted based on the first configuration information when the transmission of low-latency data is required, the MsgA is transmitted based on the second configuration information when the transmission of normal data is required, and transmission latency required for the low-latency data is shorter than transmission latency required to transmit the normal data.

15. The terminal of claim 12, wherein when transmitting MsgA to the base station on the basis of the first configuration information for the low-latency random access procedure, the instructions allow the terminal to:
select a random access preamble;
generate a random access payload;
generate the MsgA including the random access preamble and the random access payload;
transmit the MsgA to the base station; and
increase a preamble transmission counter indicating the number of transmissions of MsgA.

16. The terminal of claim 12, wherein:
the instructions allow the terminal to perform a normal two-step random access procedure when the MsgB is not received in the section corresponding to the maximum number of low-latency transmissions, and
the maximum number of transmissions for the normal two-step random access procedure is greater than the maximum number of low-latency transmissions.
